(19) United States
(12) Patent Application Publication
(10) Pub. No.: US 2007/0007360 A1
(43) Pub. Date: Jan. 11, 2007

(54) IMAGE CAPTURING ELEMENT PACKAGE FOR ELECTRONIC ENDOSCOPE

(75) Inventors: Takayuki OGINO, Tokyo (JP); Kazuyuki YAMAMOTO, Tokyo (JP); Akihiro ITO, Tokyo (JP); Seiichiro OKAMURA, Ibaraki (JP); Tomokazu YAMASHITA, Ibaraki (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/456,253

(22) Filed: Jul. 10, 2006

(30) Foreign Application Priority Data
Jul. 11, 2005 (JP) 2005-201111

(51) Int. Cl. G06K 21/06

(52) U.S. Cl. 235/495

(57) ABSTRACT

An image capturing element package for an electronic endoscope is provided with a solid-state image capturing element, an insulating base member made of electronically insulating material and configured to hold the image capturing element, a metallic package housing surrounding the solid-state image capturing element, a proximal end portion of the metallic package housing being air-tightly welded to the insulating base member, a window portion being formed on a front end surface of the metallic package housing, a cover glass air-tightly secured to the window portion, and a housing reinforcing member arranged along an inner surface of the metallic package housing, the housing reinforcing member being formed not to deform when a force exceeding strength at which the package housing is durable against deformation.

### BACKGROUND OF THE INVENTION

The present invention relates to an image capturing element package for an electronic endoscope which is built in at a distal end portion of an insertion section of the electronic endoscope.

Generally, the image capturing element package for the electronic endoscope is configured such that a solid-state image capturing element is held by an insulating member made of electrically insulating material, to which a base portion of a metallic package housing surrounding the solid-state image capturing element is air-tightly coupled. Further a window section is formed on a front surface of the package housing, to which a transparent cover glass is air-tightly secured. An example of such a configuration is disclosed in Japanese Patent Provisional Publication No. P2003-258221A.

After an endoscopic diagnosis is finished, the used endoscope is accommodated in a high-pressure steam sterilizer for sterilization. In a pre-vacuum process of the high-pressure steam sterilizer, the barometric pressure inside the endoscope is reduced significantly. However with the air-tight structure, the pressure inside the package housing stays unchanged at the air pressure. Therefore, due to the difference of the barometric pressures inside and outside the package housing, it is deformed in a direction it distends. Such a deformation causes the center of the package housing to shift with respect to the optical axis of an objective optical system for the image capturing element and/or out-of-focus condition, and the quality of an image captured by the image capturing element is deteriorated. Further, since the package housing is typically configured to have a tubular shape with a relatively thin wall. Therefore, the package housing may sometimes be deformed relatively easily by an external force applied thereto.

In order to avoid such a deformation, it may be effective to configure the package housing to have a relatively thick wall so that it hardly deforms with the pressure difference and/or external force, however, in view of manufacturing technology and/or manufacturing cost, it may not be always easy to make the wall of the package housing sufficiently thick.

### SUMMARY OF THE INVENTION

The aspects of the present invention are advantageous in that there is provided an improved image capturing element package for an electronic endoscope which will not be deformed with inside/outside pressure difference caused by the sterilizer and have durability against variation of barometric pressure outside the package.

According to aspects of the invention, there is provided an image capturing element package for an electronic endoscope, including a solid-state image capturing elements an insulating base member made of electronically insulating material and configured to hold the image capturing element, a metallic package housing surrounding the solid-state image capturing element, a proximal end portion of the metallic package housing being air-tightly welded to the insulating base member, a window portion being formed on a front end surface of the metallic package housing, a cover glass air-tightly secured to the window portion, and a housing reinforcing member arranged along an inner surface of the metallic package housing, the housing reinforcing member being formed not to deform when a force exceeding strength at which the package housing is durable against deformation.

Inner surfaces of the metallic package housing may be configured to form a rectangular cross section having four sides, and outer surfaces of the housing reinforcing member may be configured to contact the inner surfaces of the metallic housing reinforcing member forming the rectangular cross section, respectively.

A rear end surface of the housing reinforcing member may be configured to contact a front end surface of the insulating base member.

Surfaces of the housing reinforcing member oriented frontward may be arranged to contact a rear side surface of a member attached to a rear side surface of the cover glass, a clearance between the cover glass and an image capturing surface of the solid-state image capturing element being defined by the arrangement of the housing reinforcing member.

Surfaces of the housing reinforcing member oriented frontward may be arranged to contact a rear side surface of the cover glass, a clearance between the cover glass and an image capturing surface of the solid-state image capturing element being defined by the arrangement of the housing reinforcing member.

The member attached to the rear side of the cover glass may include at least one of a mask formed to block unnecessary light at a peripheral portion of a path of light directed to the image capturing surface to form an object image thereon and an optical filter configured to cut light having a predetermined wavelength.

Tip end surfaces of the housing reinforcing member directly contact an inner surface of a tip end portion of the package housing.

Surfaces of the housing reinforcing member oriented frontward may be arranged to contact a rear side surface of the cover glass, a clearance between the cover glass and an image capturing surface of the solid-state image capturing element being defined by the arrangement of the housing reinforcing member.

### BRIEF DESCRIPTION OF THE ACCOMPANYING DRAWINGS

FIG. 1 is a cross-sectional side view of an image capturing element package according to a first embodiment of the invention.

FIG. 2 is a cross-sectional view taken along line II-II of FIG. 1.

FIG. 3 is an exploded perspective view of a tip portion of an inserting section of the electronic endoscope according to the first embodiment.

FIG. 4 is a cross-sectional side view of a tip portion of the inserting section of the electronic endoscope according to the first embodiment.

FIG. 5 is a cross-sectional side view of an image capturing element package according to a second embodiment of the invention.

FIG. 6 is a cross-sectional side view of an image capturing element package according to a third embodiment of the invention.

FIG. 7 is a cross-sectional side view of an image capturing element package according to a fourth embodiment of the invention.

FIG. 8 is a cross-sectional side view of an image capturing element package according to a fifth embodiment of the invention.

### DETAILED DESCRIPTION OF THE EMBODIMENTS

Hereinafter, referring to the accompanying drawings, image capturing element package according to embodiments of the invention will be described.

First Embodiment

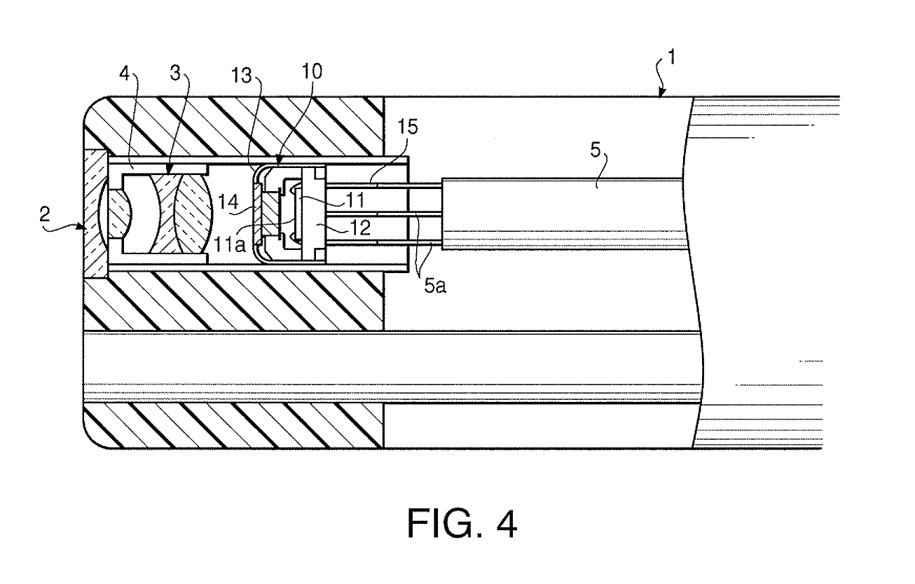

FIG. 4 shows a distal end portion of all inserting section 1 of an electronic endoscope according to a first embodiment of the invention. As shown in FIG. 4, on a front end surface of the inserting section 1, an observation window 2 is formed. On the inner side of the observation window 2, an objective optical system 3, which is accommodated in a objective optical system unit frame 4, is provided.

On a rear side (i.e., on the right-hand side) of the objective optical system 3, an image capturing element package 10 is arranged. In side the image capturing element package 10, a solid-state image capturing element 11 is accommodated. The package 10 is arranged such that an image capturing surface 11a of the solid-state image capturing element 11 coincides with an image plane of the objective optical system 3.

The solid-state image capturing element 11 is held by the insulating base member 12 and arranged within a room which is air-tightly enclosed by a package housing 13 and a cover glass 14. From the insulating base member 12, a plurality of connection terminals 15 extend rearward, to which signal lines 5a of a signal cable 5 are connected. The signal cable 5 runs through the inserting section 1 of the endoscope.

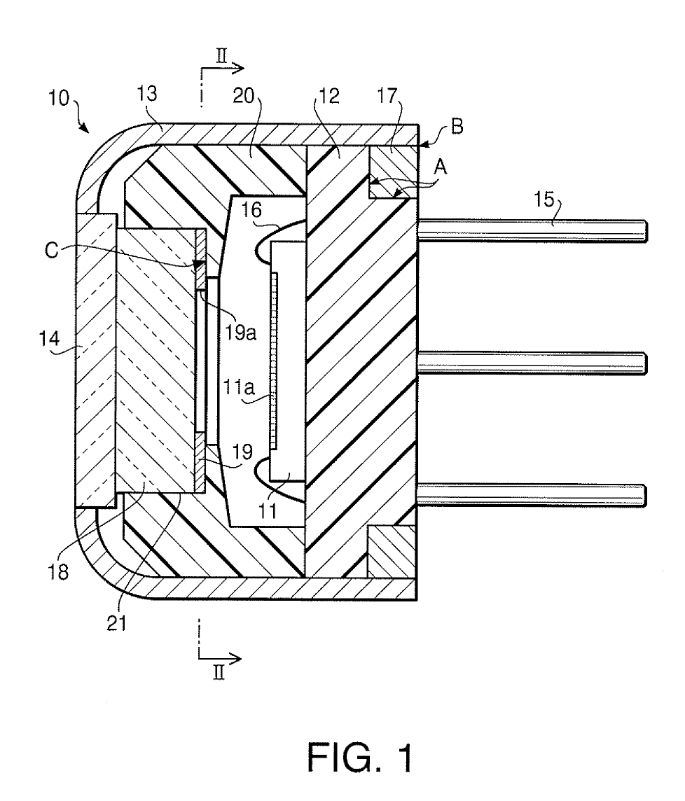

FIG. 1 is an enlarged cross-sectional view of the image capturing package 10. According to the illustrative embodiment, the insulating base member 12 is a substantially rectangular solid formed of electrically insulating material such as ceramic. On a front end surface of the insulating base member 12, the solid-state image capturing element 11 is fixedly secured with adhesive agent.

In FIG. 1, 16 denotes bonding wires which are connected to an inner circuit of the image capturing element 11. The other ends of the boding wires 16 are connected to connection terminals 15 via an electric circuit (not shown) including resistors, condensers or IC's.

An outer shape of the rear half portion of the insulating member 12 is stepped to be thinner than the front half portion. Surrounding the rear half portion (i.e., thinner portion), a looped metallic member 17 is wound tightly, which is air-tightly adhered with the insulating base member 12 with inorganic adhesive agent. This portion will be referred to as adhered portion A.

In FIG. 1, 13 denotes a metallic package housing which is provided to surround the solid-state image capturing element 11 air-tightly so that steam or the like will not penetrate the solid-state image capturing element 11 when high-temperature high-pressure steam sterilization is performed. The rear half portion of the package housing 13 is arranged to surround the insulating base member 12, and the rear end portion of the package housing 13 is welded with the looped member 17 along the entire loop. This portion will be referred to as a welded portion B.

A cover glass 14, which is a rectangular plate formed with transparent optical glass is air-tightly fitted into a window section formed at a central area of the front end surface of the package housing 13, and adhered thereto with inorganic adhesive agent. On an inner surface (i.e., rearward surface) of the cover glass 14, an optical filter 18 provided with a coating for cutting light having a predetermined wave length (e.g., light around the infrared area and YAG laser light) is adhered.

On the rearward surface of the optical filter 18, a mask 19 for blocking unnecessary light at a peripheral area of an optical path of light projecting an object image on the image capturing surface 11a is adhered. It should be noted that, according to this illustrative embodiment, both the optical filter 18 and the mask 19 have a round shape, and have substantially the same outer diameter

In FIG. 1, 20 denotes a housing reinforcing member that prevents deformation of the package housing 13. The housing reinforcing member 20 is made of high-rigid plastic material such as PEEK (Polyether Ether Ketone) and PPS (Polyphenylene Sulfide), ceramic material similar to material of the insulating base member 12 or metallic material, and formed to be more resistant against deformation than the package housing 13.

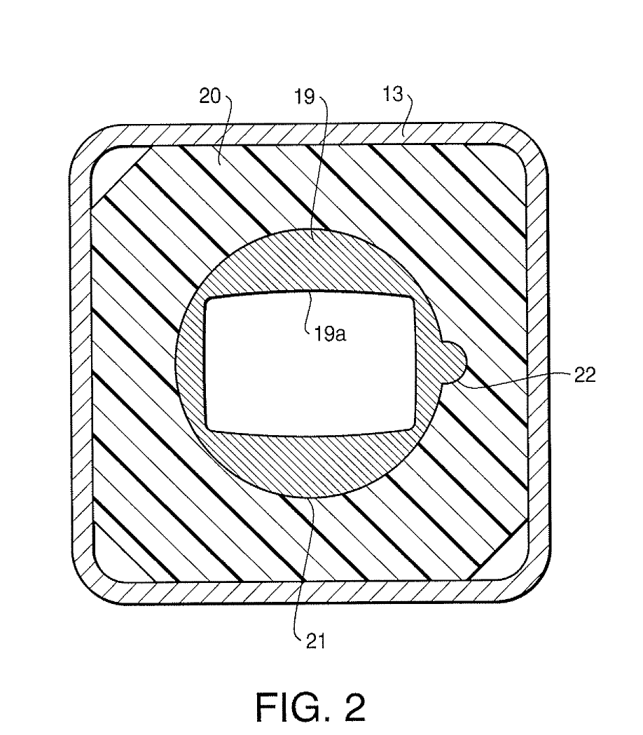

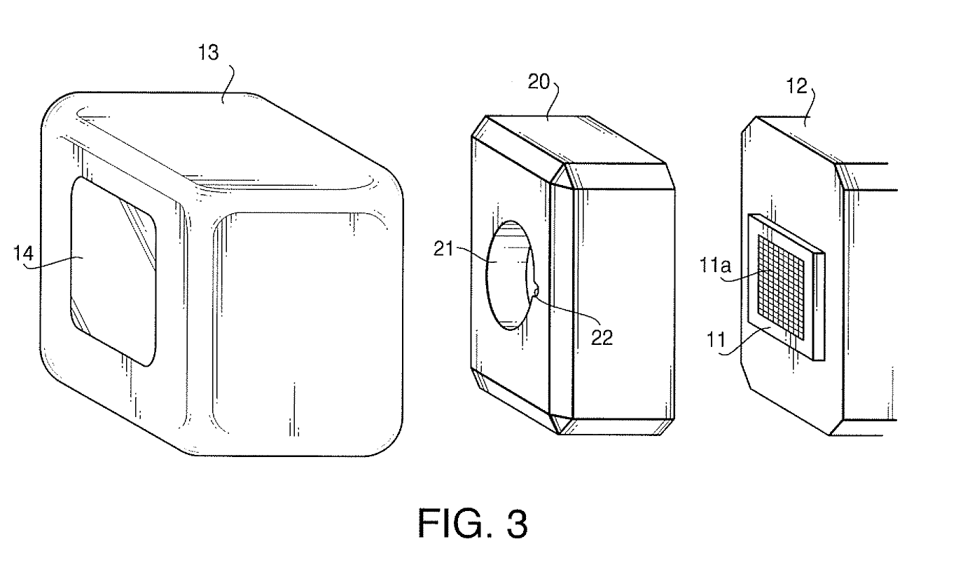

The housing reinforcing member 20 is formed to have a rectangular cross section such that the outer peripheral thereof contacts four inner circumferential surface of the package housing 13 as shown in FIG. 2 which is a cross section take along line II-II of FIG. 1 and FIG. 3 which is an exploded perspective view. Four corners of the housing reinforcing member 20 are chamfered so as not to interfere with the package housing 13. 19a denotes an edge of a window formed in the mask 19, 22 denotes a engage portion that determines a positional relationship of the mask 19 with respect to the housing reinforcing member 20.

On a front side of the housing reinforcing member 20, a receiving opening 21 to which the optical filter 18 and the mask 19 are fitted is formed. As clearly shown in FIG. 1, a rear side surface of the mask 19 (i.e., a left-hand side surface; which will be referred to as a contact surface C) contacts a bottom surface of the receiving opening 21, and the rear side surface of the housing reinforcing member 20 contacts the front side surface (i.e., the right-hand side surface) of the insulating base member 12 at its peripheral area.

Thus, a clearance between the cover glass 14 and the image capturing surface 11a of the solid-state image capturing element 11 is fixed to have a predetermined constant amount by the housing reinforcing member 20. That is, when the package housing 13 is welded with the looped member 17, without paying particular attention to the clearance, it (the clearance between the cover glass 14 and the image capturing surface 11a) can be set accurately.

It should be stressed that, since the housing reinforcing member 20 is arranged along the inner surface of the package housing 13, the package housing 13 becomes more resistant to deformation when a force is applied to the image capturing element package 10, such as when the package 10 is being assembled or when it is placed in an environment in which a large inside/outside pressure differential exists inside the sterilizer.

Second through Fifth Embodiments

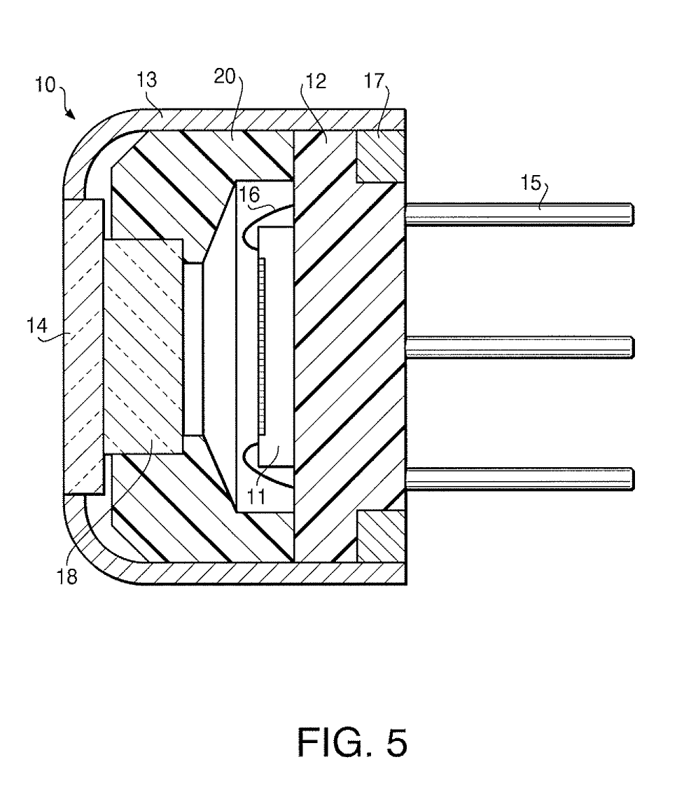

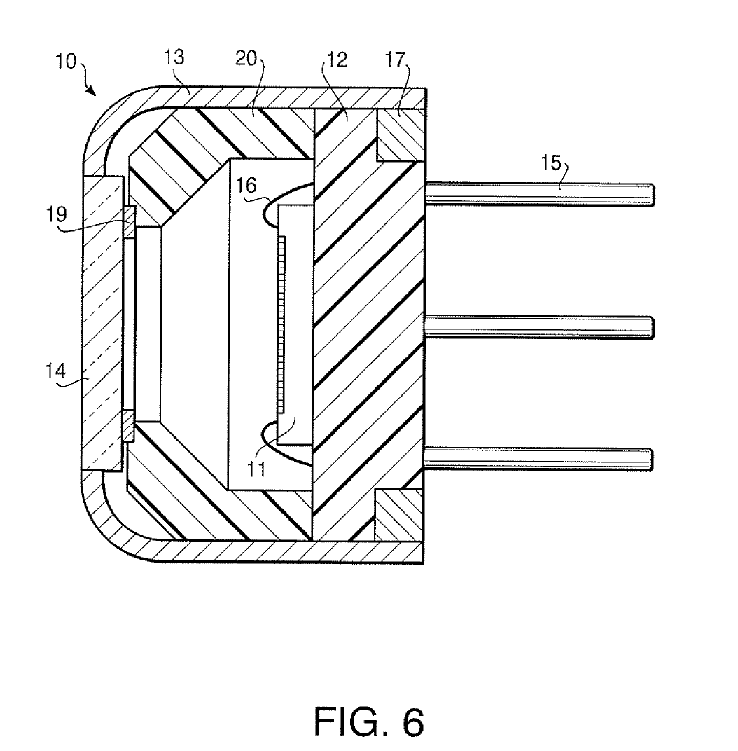

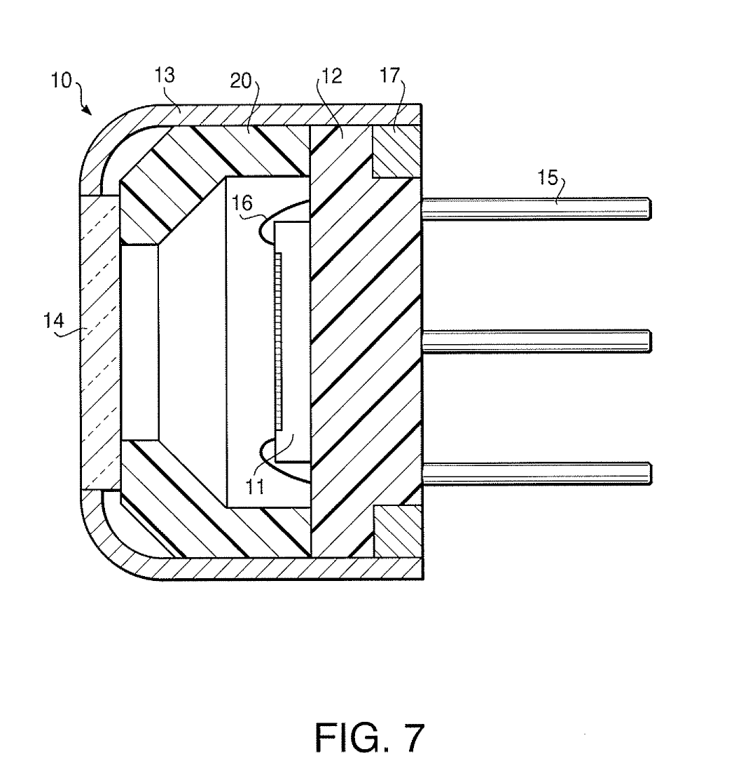

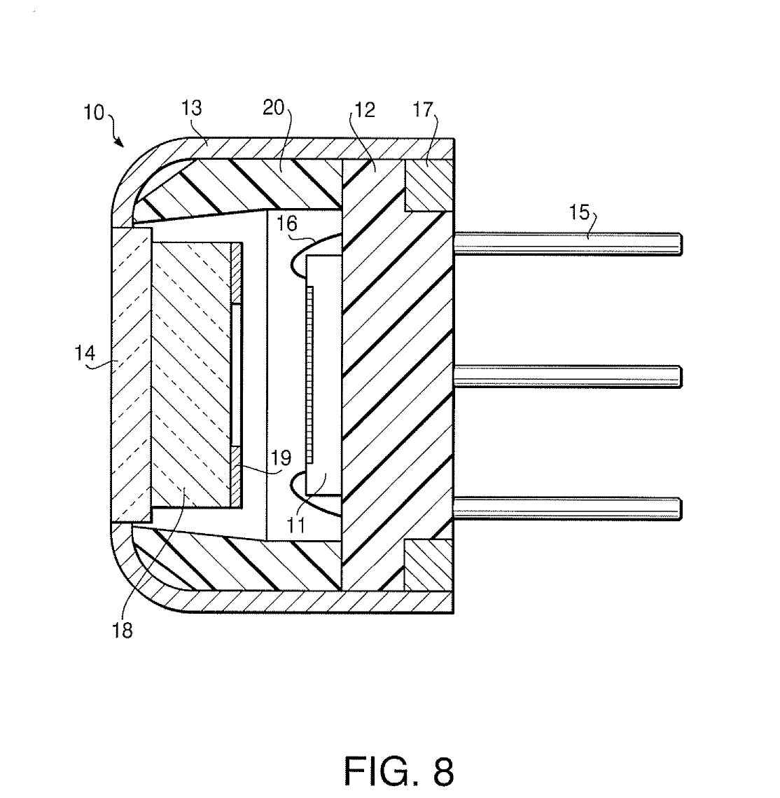

It is appreciated that the present invention is not limited to the configuration described with reference to the illustrative first embodiment, and can be modified in various ways. For example, as shown in FIGS. 5 and 6 (second and third embodiments), only one of the optical filter 18 and the mask 19 may be adhered onto the rear surface of the cover glass 14. Alternatively, as shown in FIG. 7 (fourth embodiment), the front side ends of the housing reinforcing member 20 may directly contact the rear surface of the cover glass 14. Further alternatively, as shown in FIG. 8 (fifth embodiment), the front side ends of the housing reinforcing member 20 may directly contact the inner surface of the front end portion of the package housing 13.

The present disclosure relates to the subject matter contained in Japanese Patent Application No. 2005-201111 filed on Jul. 11, 2005, which is expressly incorporated herein by reference in its entirety.

What is claimed is:

1. An image capturing element package for an electronic endoscope, comprising:
a solid-state image capturing element;
an insulating base member made of electronically insulating material and configured to hold the image capturing element;
a metallic package housing surrounding the solid-state image capturing element, a proximal end portion of the metallic package housing being air-tightly welded to the insulating base member, a window portion being formed on a front end surface of the metallic package housing;
a cover glass air-tightly secured to the window portion; and
a housing reinforcing member arranged along an inner surface of the metallic package housing, the housing reinforcing member being more resistant to deformation than the package housing.

2. The image capturing element package according to claim 1,
wherein inner surfaces of the metallic package housing form a rectangular cross section having four sides, outer surfaces of the housing reinforcing member contacting the inner surfaces of the metallic package housing forming the rectangular cross section, respectively.

3. The image capturing element package according to claim 1,
wherein a rear end surface of the housing reinforcing member contacts a front end surface of the insulating base member.

4. The image capturing element package according to claim 3,
wherein surfaces of the housing reinforcing member oriented frontward are arranged to contact a rear side surface of a member attached to a rear side surface of the cover glass, a clearance between the cover glass and an image capturing surface of the solid-state image capturing element being defined by the arrangement of the housing reinforcing member.

5. The image capturing element package according to claim 4,
wherein the member attached to the rear side of the cover glass includes at least one of a mask formed to block unnecessary light at a peripheral portion of a path of light directed to the image capturing surface to form an object image thereon and an optical filter configured to cut light having a predetermined wavelength.

6. The image capturing element package according to claim 3,
wherein surfaces of the housing reinforcing member oriented frontward are arranged to contact a rear side surface of the cover glass, a clearance between the cover glass and an image capturing surface of the solid-state image capturing element being defined by the arrangement of the housing reinforcing member.

7. The image capturing element package according to claim 6,
wherein the member attached to the rear side of the cover glass includes at least one of a mask formed to block unnecessary light at a peripheral portion of a path of light directed to the image capturing surface to form an object image thereon and an optical filter configured to cut light having a predetermined wavelength.

8. The image capturing element package according to claim 1,
wherein tip end surfaces of the housing reinforcing member directly contact an inner surface of a tip end portion of the package housing.
